(19) United States
(12) Patent Application Publication
(10) Pub. No.: US 2005/0043076 A1
(43) Pub. Date: Feb. 24, 2005

(54) RPG toys playing process and RPG toy for playing the process

(76) Inventor: Yuhjen James Lin, Tapei Hsien (TW)

Correspondence Address: BACON & THOMAS, PLLC, 625 SLATERS LANE, FOURTH FLOOR, ALEXANDRIA, VA, 22314, US

(21) Appl. No.: 10/644,833

(22) Filed: Aug. 21, 2003

(51) Int. Cl. A63F 13/00

(52) U.S. Cl. 463/9; 463/42

(57) ABSTRACT

An RPG Toy playing process includes the step of obtaining a story background from a book or an interactive CD, the step of using a game card as a clue or data to enter game mode and complete all game objectives when understood the story background, and the step of logging in a web site or a specific software to obtain the ending of the story or a prize. The recognition of the clue or data is done by means of inserting a punched card into a main unit. The main unit uses contact copper leaves, photoelectric sensor, barcode reader, IC chip reader, or voice recognized IC to achieve recognition action.

### BACKGROUND OF THE INVENTION

1. Field of the Invention

The present invention relates to a playing process of an RPG Toy (Role-Play-Game Toy). The playing process of the RPG Toy includes three steps: (1) obtaining a story background from a children's book or interactive CD to understand the missions or objectives; (2) using game cards or other game materials within the toy as a clue or data to learn and conduct missions and finally complete objectives; (3) optionally inputting the password gained from the toy into CD or logging in a web site to obtain the ending of the story or a prize.

2. Description of the Related Art

Various educational toys have been disclosed, and have appeared on the market. Some conventional educational toys are static and one-way learning, and children are not able to know how much knowledge they have learned. The others provide sound and lighting effects. However, these conventional educational toys focus on how to teach knowledge, and they look like learning kits more than toys. The players might become tired of playing after several trials.

### SUMMARY OF THE INVENTION

The present invention has been accomplished under the circumstances in view. It is the main object of the present invention to provide an RPG toy and role-playing game, that runs in an interactive manner to attract the players, i.e., by means of learning the story background and acting a role and using obtained clues to finish the missions in the puzzle game.

The role-playing game, comprises the steps of a) showing a story background by means of a children's book or interactive CD, for enabling to the player to puzzle out the puzzle according to the story background; b) the player learning all clues or data at the first stage; c) the player being tested how they know about the obtained clue or data; and d) the player playing the game by using the obtained clues and data and finishing the mission subject to the game played, and then optionally using the code thus obtained to log into a software or an assigned web site in the Internet so as to find out the ending of the story or a prize.

The RPG toy comprises a main unit, and game cards. The main unit comprises an insertion hole adapted to receive the cards, a set of buttons for operation by the player to give an answer, and detector means adapted to detect hole positions of the cards. The cards are to be inserted into the insertion hole of the main unit, having a plurality of holes adapted to produce clue or data when detected by the detector means. The detector means includes contact copper leaves, CDS, or infrared photoelectric component. The cards can be made having barcode or IC chips. The main unit has a barcode or IC chip reader adapted to read the barcode/IC chip of the card so as to obtain a clue or data. Alternatively, the main unit can be made having a voice IC and a microphone for inputting of the player's voice to recognize the clue or data.

### BRIEF DESCRIPTION OF THE DRAWINGS

FIG. 1 illustrates the structure of a prior art design.

FIG. 2 is an exploded view of the first embodiment of the present invention.

FIG. 3 is a sectional plain view of the first embodiment of the present invention.

### DETAILED DESCRIPTION OF THE PREFERRED EMBODIMENT

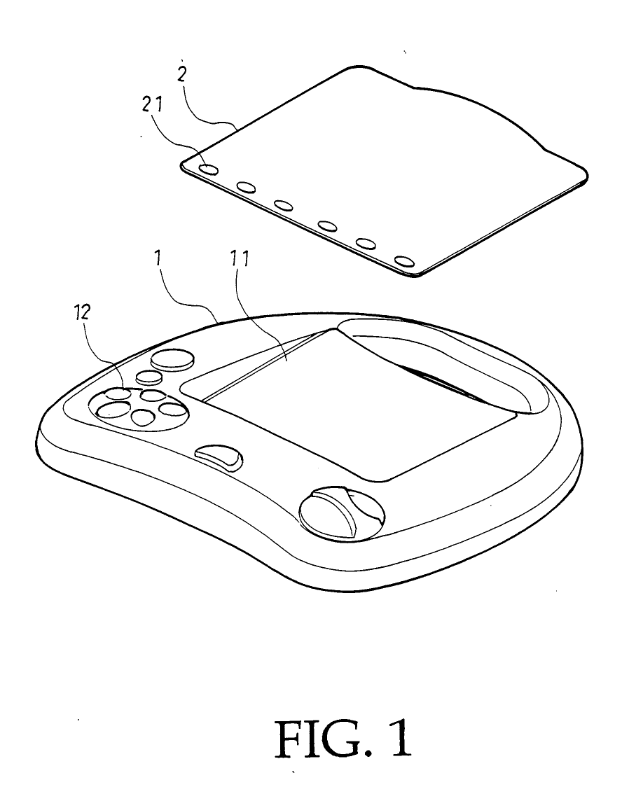

Referring to FIG. 1, an RPG Toy is shown comprising a main unit 1 used as the physical platform for the game, and a card 2. The main unit 1 comprises an insertion hole 11 adapted to receive the card 2, having contact copper leaves, photoelectric components, bar code scanner or card reader IC (not shown) provided inside the insertion hole 11, and selector buttons 12 on the outside wall of the main unit 1 for pressing by the user to repeat the information or offer some hints.

The card 2 is used as a clue to finish with the main unit 1 the target of the puzzle game, having a plurality of holes 21 at different locations. When inserted the card 2 in the insertion hole 11, the holes 21 cause connection/short circuit of the contact copper leaves or induction of the photoelectric components for recognition of the clue or data, so that the user can operate the cards 2 to give an answer to the main unit 1.

The card 2 can be made having installed therein a barcode or IC chip. By means of a barcode reader or IC chip card reader, the main unit 1 recognizes the clue or data in the barcode or IC chip. Similarly, a voice recognized IC may be used to respond input voice from the user through a microphone, achieving the clue or data recognition action.

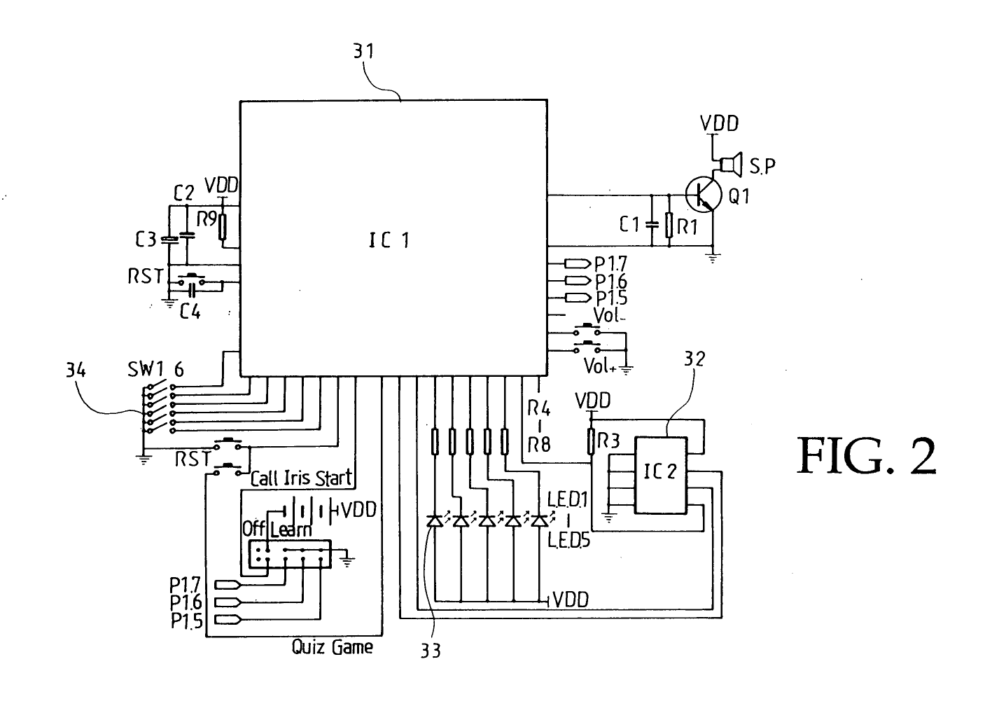

FIG. 2 is a circuit diagram of the present invention. As illustrated, the present invention comprises a microprocessor 31 and a memory 32. The microprocessor 31 has set therein an operation program. The microprocessor 31 controls LEDs 33 as signal indicators to detect the hole positions of the card or show some results. The user switched the switches 34 to play in different game modes.

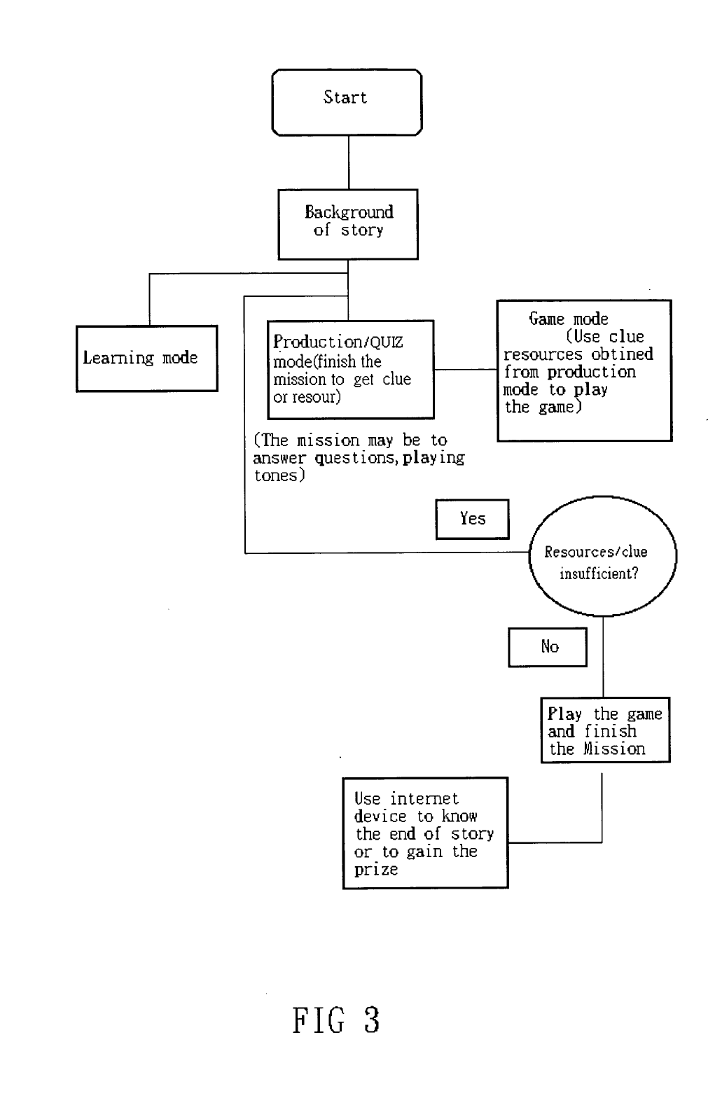

FIG. 3 is a flow chart of the RPG Toy according to the present invention. The RPG Toy comprises the steps of:
1. displaying the background of the story by means of a children's book or interactive CD for enabling the player to know clues by means of a learning mode;
2. the player collecting the ‘necessary resources’ (setting in the game) by responding to the correct answers so as to obtain a clue or data;
3. the player processing the missions by using the obtained clue or data. Once data or clue is insufficient, the player needs to return to the previous mode to obtain clues or data.
4. the user obtaining a code when finished the mission, and then using the code to log in the assigned web site in the Internet so as to obtain the ending of the story or prize (scores).

By means of the aforesaid operation procedure, the player conducts the game objectives and then obtains the necessary clue or data to complete the missions, and then obtains the code to log in the assigned web site in the Internet when pulled out the puzzle, so as to further obtain the ending of the story or a prize (scores).

As indicated above, the invention has the advantages as follows:
1. By means of acting a role in the game, the player is linked to the character or scene in the story.
2. By means of the game, the player gains experience and learns certain knowledge.

Further, when finished the mission of the puzzle game, the player will be proud of his (her) achievement.

1. A role-playing game comprising the steps of:
a) showing a story background by means of a children's book or interactive CD, for enabling to the player to puzzle out the puzzle according to the story background;
b) the player obtaining a clue or data when puzzled out the puzzle;
c) the player playing the game subject to the obtained clue or data; and
d) the player playing the game and obtaining a code when finishing the mission subject to the game played, and then optionally using the code thus obtained to log in an assigned web site in the Internet so as to obtain the ending of the story or a prize.

2. An RPG (role-playing game) Toy comprising:
a main unit, said main unit comprising an insertion hole adapted to receive a card, a set of buttons for operation by the player to give an answer, and detector means adapted to detect hole positions of a card inserted into said insertion hole; and
a card for insertion into said insertion hole to provide a clue or data, said card having a plurality of holes adapted to produce clue or data when detected by said detector means.

3. The RPG toy as claimed in claim 2, wherein said detector means includes contact copper leaves, CDS, infrared photoelectric element, and voice recognizer.

4. The RPG Toy as claimed in claim 2, wherein said card has a barcode/IC chip; said main unit has barcode/IC chip reader adapted to read the barcode/IC chip of said card so as to obtain a clue or data.

5. The RPG Toy as claimed in claim 2, wherein said main unit comprises a voice IC and a microphone for input of the player's voice to recognize the clue or data.
